(19) United States
(12) Patent Application Publication
(10) Pub. No.: US 2018/0196081 A1
(43) Pub. Date: Jul. 12, 2018

(54) SHEAR-TYPE PIEZOELECTRIC SENSOR

(71) Applicant: Xiamen Niell Electronics Co., Ltd., Xiamen (CN)

(72) Inventors: Yongzhong Nie, Xiamen (CN); Jingling Xu, Xiamen (CN)

(21) Appl. No.: 15/739,774

(22) PCT Filed: Jun. 26, 2015
(86) PCT No.: PCT/CN2015/082503

§ 371 Date: Dec. 25, 2017

(51) Int. Cl. G01P 15/09; G01P 15/08

(52) U.S. Cl. CPC G01P 15/0915; G01P 15/0802

(57) ABSTRACT

A shear-type piezoelectric sensor and a method for manufacturing the shear-type piezoelectric sensor are provided. The shear-type piezoelectric sensor comprises a collar, a piezoelectric element, and a mass block, wherein the collar is disposed outside a fastening nail, the fastening nail can be screwed onto a support arranged on a base; the piezoelectric element is disposed outside the collar; the mass block is disposed outside the piezoelectric element, the collar is expanded as the fastening nail is screwed onto the support, the piezoelectric element is expanded by an expanding force transferred from the collar, and the mass block is expanded by an expanding force transferred from the piezoelectric element. The shear-type piezoelectric sensor can be assembled easily and has high sensitivity and can be used in a high-temperature environment.

### BACKGROUND OF THE INVENTION

### 1. Field of the Invention

The present invention relates to a sensor, and more particularly to a shear-type piezoelectric sensor.

### 2. Description of the Prior Art

Piezoelectric sensors have excellent properties, such as wide frequency band, high sensitivity, great signal to noise ratio, simple structure, reliable operation, and light weight. Therefore, the piezoelectric sensors are widely used in aerospace, shipbuilding, rail transportation, power detection (wind power, nuclear power, and thermal power), industrial testing, and many other technical fields.

One of piezoelectric sensors is a shear-type piezoelectric sensor. Shear-type piezoelectric sensors are classified into an annular shear-type piezoelectric sensor, a planar shear-type piezoelectric sensor, and a triangular planar shear-type piezoelectric sensor.

In an annular shear-type piezoelectric sensor, a piezoelectric element and a mass block are fixed by friction on an annular contact surface and by adhesive bonding. When the annular shear-type piezoelectric sensor is subjected to a great force, the friction on the annular contact surface of the piezoelectric element and the mass block becomes weaker, so the annular shear-type piezoelectric sensor is less resistant to overload. In addition, in the high-temperature environment, the adhesive for bonding the piezoelectric element and the mass block may melt or fail, resulting in a decrease in the stability of the piezoelectric element and the mass block. Therefore, the annular shear-type piezoelectric sensor should not be used in high-temperature and strong applied force environment.

The planar shear-type piezoelectric sensor has a similar positive end compression structure. The piezoelectric element and the mass block are fixed through a lateral preload exerted by a lateral screw rod. In the planar shear-type piezoelectric sensor, it is more difficult to align the screw rod with the piezoelectric element and the mass block during installation, so the assembly is complicated and the lateral sensitivity is poor. In addition, it is difficult to improve the frequency response of the planar shear-type piezoelectric sensor.

In the triangular planar shear-type piezoelectric sensor, three sector mass blocks and three piezoelectric plates are fastened to a triangular prism through an annular pre-tensioner. Like the planar shear-type piezoelectric sensor, the installation and alignment of the pre-tensioner are more difficult. Therefore, the assembly is complicated and the lateral sensitivity is poor. In addition, because the mass block and the circuit board are connected by adhesive bonding, it is not suitable for high temperature environment.

### SUMMARY OF THE INVENTION

According to one aspect of the present invention, a shear-type piezoelectric sensor is provided. The shear-type piezoelectric sensor comprises a collar, a piezoelectric element, and a mass block. The collar is disposed outside a fastening nail. The fastening nail is screwed to a support disposed on a base. The piezoelectric element is disposed outside the collar. The mass block is disposed outside the piezoelectric element. The collar is expanded as the fastening nail is screwed to the support. The piezoelectric element is expanded by an expanding force transferred from the collar. The mass block is expanded by an expanding force transferred from the piezoelectric element.

According to another aspect of the present invention, a method for manufacturing a shear-type piezoelectric sensor is provided. The method comprises the steps of: providing a collar disposed outside a fastening nail, wherein the fastening nail is screwed to a support disposed on a base and wherein the collar is expanded as the fastening nail is screwed to the support; providing a piezoelectric element disposed outside the collar, wherein the piezoelectric element is expanded by an expanding force transferred from the collar; and providing a mass block disposed outside the piezoelectric element, wherein the mass block is expanded by an expanding force transferred from the piezoelectric element.

According to the shear-type piezoelectric sensor of the present invention, the piezoelectric element and the mass block are expanded by the expanding force transferred from the collar as the fastening nail is screwed to the support, so that the shear-type piezoelectric sensor can be assembled with ease and has high sensitivity. In addition, because no adhesive is used between the collar and the fastening nail, between the piezoelectric element and the collar, and between the mass block and the piezoelectric element for fixing, the shear-type piezoelectric sensor according to the present invention can be used in a high-temperature environment.

### BRIEF DESCRIPTION OF THE DRAWINGS

Advantages and features of the inventive concept and methods of accomplishing the same will become apparent and more readily appreciated from the following description of the embodiments, taken in conjunction with the accompanying drawings, in which:

FIG. 1 is a longitudinal sectional view of the shear-type piezoelectric sensor according to an embodiment of the present invention;

FIG. 2 is a schematic cross-sectional view of the inner side of the collar according to an embodiment of the present invention;

FIG. 3 is a schematic view of the collar according to an embodiment of the present invention;

FIG. 4 is a schematic view of the collar according to another embodiment of the present invention;

FIG. 5 is a schematic view of the piezoelectric element according to an embodiment of the present invention;

FIG. 6 is a schematic view of the piezoelectric element according to another embodiment of the present invention;

FIG. 7 is a cross-sectional view of the shear-type piezoelectric sensor taken along line A-A of FIG. 1 according to an embodiment of the present invention; and

FIG. 8 shows a flowchart of the method for manufacturing the shear-type piezoelectric sensor according to an embodiment of the present invention.

### DETAILED DESCRIPTION OF THE PREFERRED EMBODIMENTS

Features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein. Hereinafter, example embodiments will be described in more detail with reference to the accompanying drawings, in which like reference numbers refer to like elements throughout. The present invention, however, may be embodied in various different forms, and should not be construed as being limited to only the illustrated embodiments herein. Rather, these embodiments are provided as examples so that this disclosure will be thorough and complete, and will fully convey the aspects and features of the present invention to those skilled in the art.

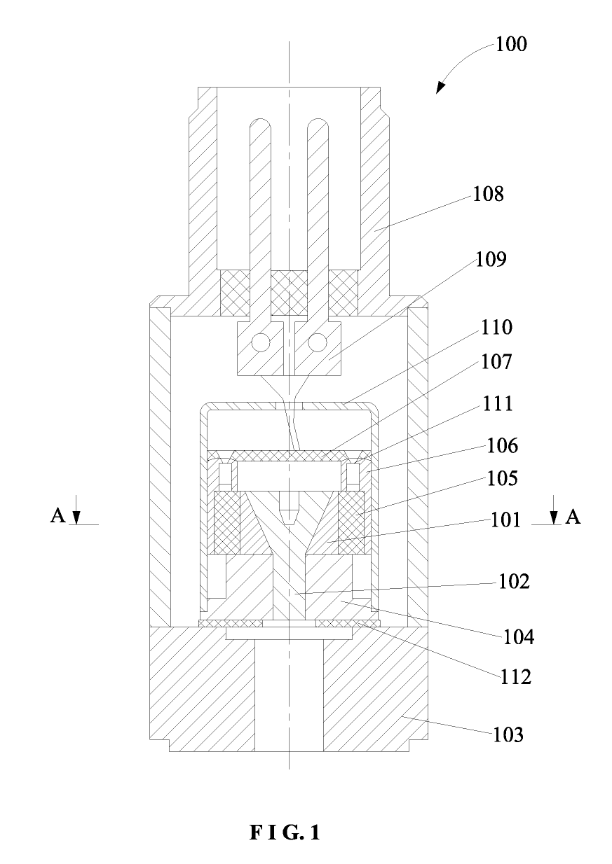

FIG. 1 is a longitudinal sectional view of a shear-type piezoelectric sensor 100 according to an embodiment of the present invention. As shown in FIG. 1, the shear-type piezoelectric sensor 100 comprises a collar 101, a piezoelectric element 105, and a mass block 106. The collar 101 is disposed outside a fastening nail 102. The fastening nail 102 is screwed to a support 104 disposed on a base 103. The piezoelectric element 105 is disposed outside the collar 101. The mass block 106 is disposed outside the piezoelectric element 105. The collar 101 is expanded as the fastening nail 102 is screwed to the support 104. The piezoelectric element 105 is expanded by an expanding force transferred from the collar 101. The mass block 106 is expanded by an expanding force transferred from the piezoelectric element 105.

According to the shear-type piezoelectric sensor 100 of the present invention, the piezoelectric conversion is realized by the shear piezoelectric effect of the piezoelectric element 105. Because the piezoelectric element 105 and the mass block 106 are correspondingly expanded by the expanding force transferred from the collar 101, the shear-type piezoelectric sensor 100 of the present invention can be assembled easily and has high sensitivity. In addition, because the piezoelectric element 105 and the mass block 106 are expanded by the expanding force, there is no need to use adhesive for fixing. The shear-type piezoelectric sensor 100 according to the present invention can be used in a high-temperature environment.

The respective components of the shear-type piezoelectric sensor 100 will be described in detail below.

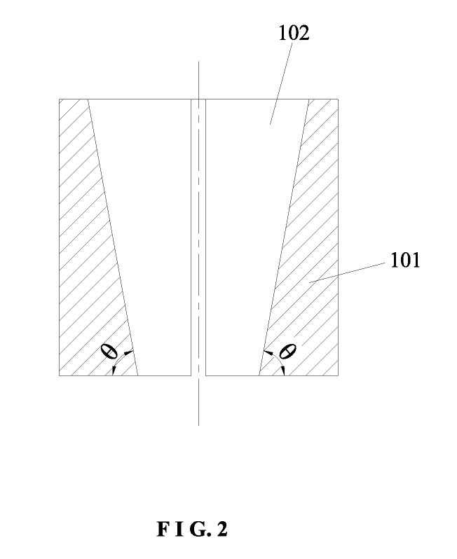

The collar 101 is expanded as the fastening nail 102 is screwed to the support 104. The collar 101 has an inner conical surface, that is, the outer side of the collar 101 may have a revolving configuration, such as a cylindrical shape. The inner side of the collar 101 may have a conical shape with a certain angle. FIG. 2 is a schematic cross-sectional view of the inner side of the collar according to an embodiment of the present invention. As shown in FIG. 2, the inner side of the collar 101 is a conical surface. The angle between the conical surface and the bottom surface is θ. The angle θ of the inner conical surface of the collar 101 may be calculated based on the moment to be applied to the fastening nail 102 to achieve a predetermined preload. The predetermined preload is a predetermined force that the designer wants the collar 101 to be expanded.

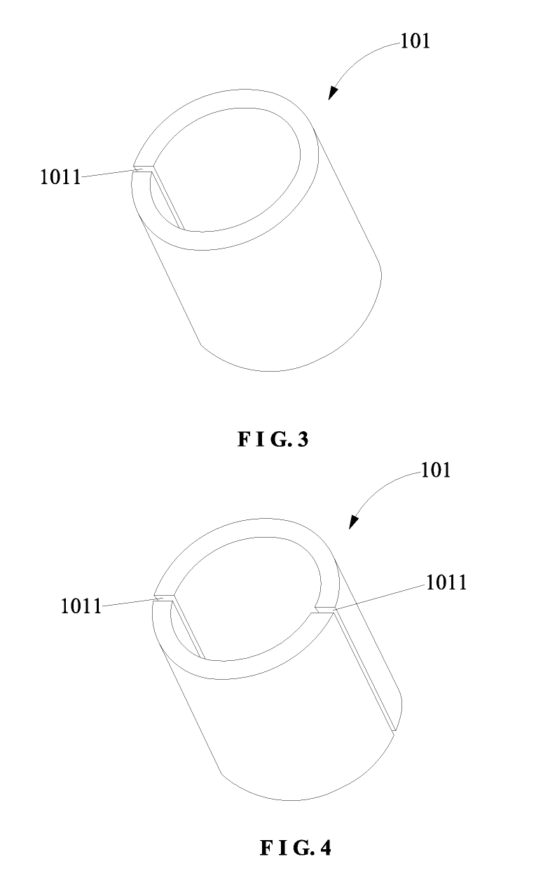

The collar 101 may have at least one through cutout. The collar 101 can be expanded when the fastening nail 102 is screwed to the support 104. In an embodiment, the collar 101 may have only one through cutout. FIG. 3 illustrates an example of the collar 101 having only one through cutout. As shown in FIG. 3, the collar 101 may have only one through cutout 1011. When the fastening nail 102 is screwed to the support 104, the opening of the through cutout 1011 is enlarged and the collar 101 is expanded. In another embodiment, the collar 101 may have two through cutouts. FIG. 4 illustrates an example of the collar 101 having two through cutouts. As shown in FIG. 4, the collar 101 may have two through cutouts 1011. The number of through cutouts of the collar 101 can be changed according to the design demand. In general, the greater the number of through cutouts, the greater the preload that is exerted to the collar 101, and the more the collar 101 to be expanded, and the greater the expanding force transferred to the piezoelectric element 105 outside the collar 101. It should be noted that the collar 101 may have more through cutouts. A person skilled in the art can set an appropriate number of through cutouts according to the design demand. It should be noted that, as shown in FIG. 2 and FIG. 3, only the outer side configuration of the collar 101 is shown for simplicity, and the inner conical configuration is not shown.

The collar 101 may be made of a variety of materials, such as stainless steel, aluminum alloy, or titanium alloy. It should be understood that these materials are given by way of example only. Those skilled in the art, upon reading the teaching of the present invention, can implement the collar 101 by using other materials.

The piezoelectric element 105 can be expanded by the expanding force transferred from the collar 101. The piezoelectric element 105 may be an axially polarized piezoelectric element. In an embodiment, the piezoelectric element 105 may have a cylindrical shape. The electric charge may be obtained from the outer surface of the cylinder opposite the inner surface of the mass block 106. However, it should be understood that the shape of the piezoelectric element 105 is not limited to the cylindrical shape. It may have any revolving configuration. In an embodiment, the piezoelectric element 105 may have a conical shape.

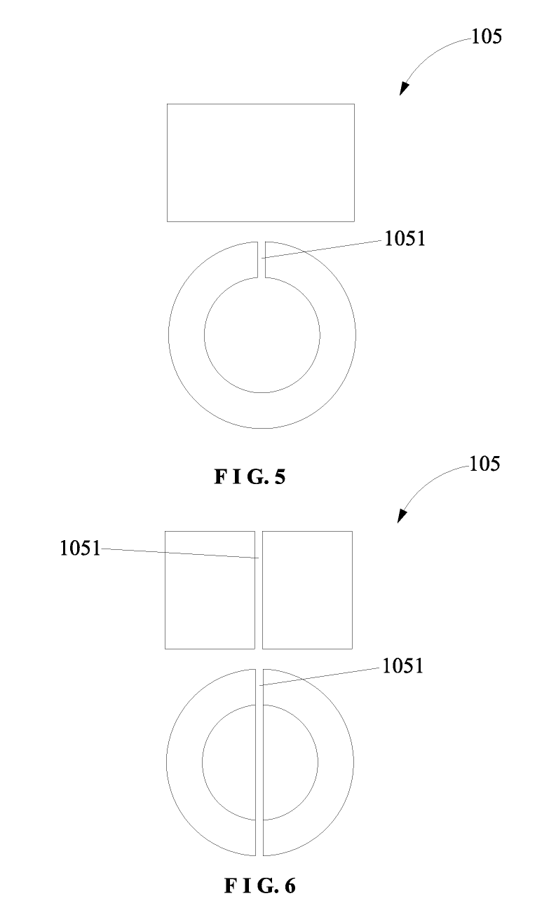

The piezoelectric element 105 may have at least one through cutout. When the collar 101 is expanded, the piezoelectric element 105 can be expanded by the expanding force from the collar 101. In an embodiment, the piezoelectric element 105 may have only one through cutout. FIG. 5 illustrates an example in which the piezoelectric element 105 has only one through cutout. As shown in FIG. 5, the piezoelectric element 105 may have only one through cutout 1051. When the collar 101 is expanded, the opening of the through cutout 1051 is enlarged and the piezoelectric element 105 is expanded. In FIG. 5, a side view of the piezoelectric element 105 is shown in the upper portion. As shown in the figure, since the piezoelectric element 105 has only one through cutout in this embodiment, the expanded view is shown as a rectangle. In another embodiment, the piezoelectric element 105 may have two through cutouts at an angle of 180 degrees. FIG. 6 illustrates an example that the piezoelectric element 105 has two through cutouts. As shown in FIG. 6, the piezoelectric element 105 may have two through cutouts 1051. Similarly, in FIG. 6, a side view of the piezoelectric element 105 is also shown in the upper portion. As shown in the figure, since the piezoelectric element 105 has two cutouts in this embodiment, the expanded view is shown as two rectangles arranged side by side. The gap between the two rectangles represents one of the cutouts 1051. It should be noted that the piezoelectric element 105 may have more through cutouts. For example, three through cutouts may be formed at an angle of 120 degrees with each other. Those skilled in the art can set an appropriate number of through cutouts according to the design demand.

In an embodiment, the piezoelectric element 105 may be a piezoelectric ceramic. In another embodiment, the piezoelectric element 105 may be a piezoelectric single crystal. Electromechanical conversion is achieved by utilizing the shear piezoelectric effect of piezoelectric ceramics or piezoelectric single crystals.

The mass block 106 is expanded by the expanding force transferred from the piezoelectric element 105. The mass block 106 is a block having a certain mass. The mass of the mass block 106 can be determined according to the design demand. The mass block 106 can be designed as a revolving configuration, or can be designed as a square shape, or can be designed as a special shape. In fact, the shape of the mass block 106 is not particularly limited as long as its bottom surface is substantially a flat bottom surface. The mass block 106 can be made of a variety of materials. Preferably, the mass block 106 is made of a metallic material with great density, such as tungsten alloy, stainless steel, or the like.

The fastening nail 102 may be a conical head locking nail with a conical surface. The conical surface of the fastening nail 102 is matched with the conical surface of the inner side of the collar 101. The fastening nail 102 can be screwed and connected to the support 104 having inner threads. Therefore, when the fastening nail 102 is screwed toward the support 104, the collar 101 disposed on the fastening nail 102 is expanded, so that the piezoelectric element 105 and the mass block 106 are also expanded.

As known from the above description, according to the shear-type piezoelectric sensor 100 of the present invention, no adhesive is used between the fastening nail 102 and the support 104, between the collar 101 and the piezoelectric element 105, and between the piezoelectric element 105 and the mass block 106 for fixing. The present invention has a simple structure and especially suitable for high temperature applications.

The shear-type piezoelectric sensor 100 according to the present invention may not include the circuit board 107 or may include the circuit board 107, thereby implementing various types of sensors. For example, in an embodiment, the shear-type piezoelectric sensor 100 may not include the circuit board 107. The shear-type piezoelectric sensor 100 may be used as an electric charge output acceleration sensor. The electric charge may be obtained from of the outer surface of the piezoelectric element 105. In another embodiment, the shear-type piezoelectric sensor 100 may include a circuit board 107. The circuit board 107 is connected to the mass block 106 through the fastening nail 102. The shear-type piezoelectric sensor 100 can be used as a voltage output acceleration sensor through impedance matching of the circuit board. In still another embodiment, the circuit board 107 may include a voltage-current conversion circuit unit so that the shear-type piezoelectric sensor 100 can be used as a current output acceleration sensor. In yet another embodiment, the circuit board 107 may include a primary integrating circuit unit so that the shear-type piezoelectric sensor 100 may be used as a vibration speed sensor. In yet another embodiment, the circuit board 107 may include a quadratic integrating circuit unit so that the shear-type piezoelectric sensor 100 may be used as a vibration displacement sensor.

Referring again to FIG. 1, in addition to the collar 101, the fastening nail 102, the base 103, the support 104, the piezoelectric element 105, the mass block 106, and the circuit board 107, the shear-type piezoelectric sensor 100 may further include a connector 108, an electrode lead 109, a shield 110, a fastening nail 111, an insulating sheet 112, a bottom base 113, and the like.

These elements 108-113 have the same function as the same components of the conventional various shear-type piezoelectric sensors. The specific arrangement of these elements may be implemented in the same manner as the conventional various shear-type piezoelectric sensors, such as by pressing, screwing or welding. However, it should be understood that the arrangement of these elements is not limited to the specific manners mentioned herein. It may adopt a conventional configuration or any configuration that will be developed in the future. It should be noted that the connection of the components 108-113 doesn't adopt adhesive either.

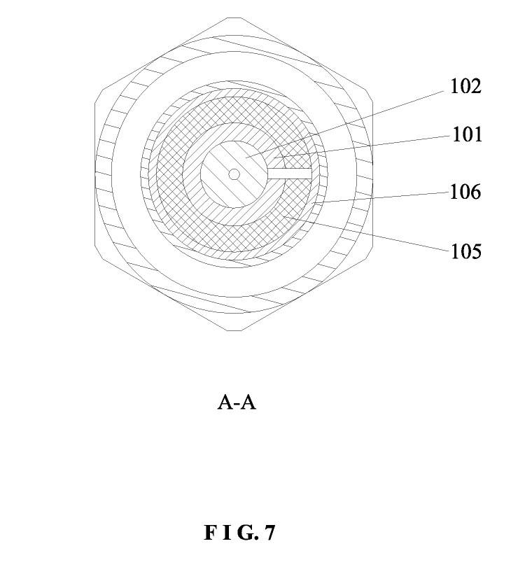

In order to more clearly illustrate the arrangement of the collar, the piezoelectric element and the mass block, FIG. 7 is a cross-sectional view of the shear-type piezoelectric sensor taken along line A-A of FIG. 1 according to an embodiment of the present invention. As shown in FIG. 7, the collar 101 is disposed outside the fastening nail 102. The fastening nail 102 may be screwed to the support 104 (not shown) provided on the base 103. The piezoelectric element 105 is disposed outside the collar 101. The mass block 106 is disposed outside the piezoelectric element 105.

The small white bar along the radial direction in FIG. 7 indicates the through cutouts of the collar 101 and the piezoelectric element 105. In this figure, the collar 101 and the piezoelectric element 105 have only one through cutout. The through cutout of the collar 101 is aligned with the through cutout of the piezoelectric element 105, as shown in the figure. More specifically, the fastening nail 102 is in contact with the inner side of the collar 101. The outer side of the collar 101 is in contact with the inner side of the piezoelectric element 105. The outer side of the piezoelectric element 105 is connected with the mass block 106.

When the shear-type piezoelectric sensor is vibrated or impacted, as the fastening nail 102 is screwed to the support, the collar 101 having the through cutout is expanded by the locking force of the fastening nail 102 and the tolerance and fit. The expanding force generated by the expansion of the collar 101 in turn causes the piezoelectric element 105 disposed outside the collar 101 to be expanded. The expanding force generated by the expansion of the collar 101 causes the mass block 106 disposed outside the piezoelectric element 105 to be expanded.

Thus, according to the shear-type piezoelectric sensor of the present invention, the piezoelectric conversion is realized by the shear piezoelectric effect of the piezoelectric element. Because the mass block and the piezoelectric element are expanded by the expanding force transferred from the collar, the assembly of the shear-type piezoelectric sensor according to the present invention is simple. In addition, the shear-type piezoelectric sensor according to the present invention can achieve low lateral sensitivity and greatly reduce transverse crosstalk due to the self-alignment and self-calibration function of conical shear. In addition, since no adhesive is used between the mass block and the piezoelectric element and/or between the mass block and the circuit board, the shear-type piezoelectric sensor according to the present invention doesn't need the process of gluing, baking and the like during manufacture, thereby greatly reducing manufacturing man-hour and improving production efficiency. The shear-type piezoelectric sensor according to the present invention is able to endure high temperature and has high-frequency g value.

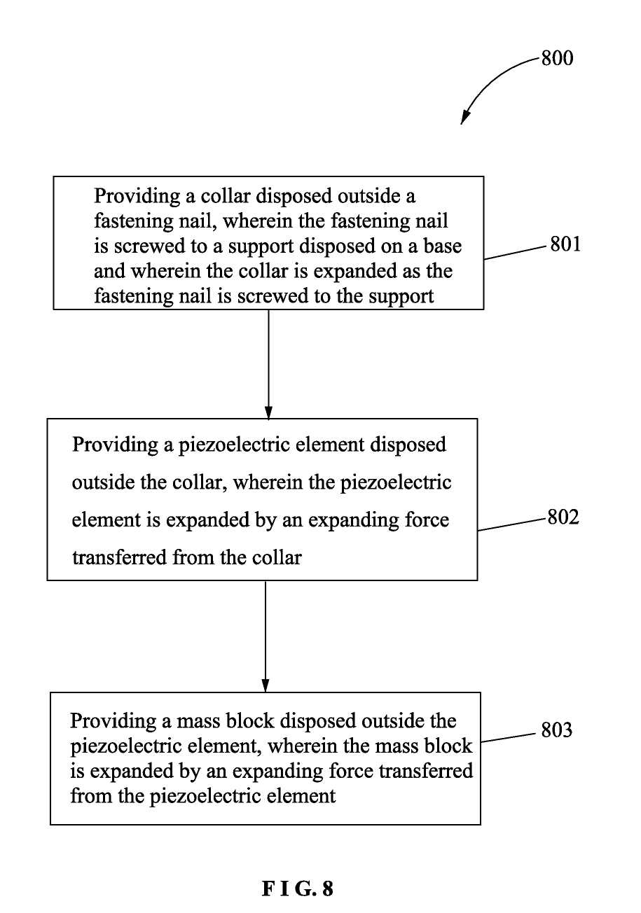

FIG. 8 shows a flowchart of a method 800 for manufacturing a shear-type piezoelectric sensor according to an embodiment of the present invention.

As shown in FIG. 8, the method 800 comprises the steps of:

step 801, providing a collar disposed outside a fastening nail, wherein the fastening nail is screwed to a support disposed on a base;

step 802, providing a piezoelectric element disposed outside the collar;

step 803, providing a mass block disposed outside the piezoelectric element. Wherein, the collar is expanded as the fastening nail is screwed to the support; wherein the piezoelectric element is expanded by an expanding force transferred from the collar; and wherein the mass block is expanded by an expanding force transferred from the piezoelectric element.

According to the method 800, a shear-type piezoelectric sensor can be manufactured that has the various advantages as mentioned above.

Reference in this description to “an embodiment” and “another embodiment” should be understood that this does not indicate that the components described in this embodiment cannot be used in another embodiment, but rather that the components described in the embodiment may be added to any of the embodiments according to the present invention. That is, any of the components in the embodiments described in this disclosure may be combined in any manner.

In the appended claims, the term “comprising” is open-ended, i.e., a sensor that includes elements other than those listed in the claims is still to be considered as falling within the scope of the claims.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A shear-type piezoelectric sensor, comprising:
a collar, the collar being disposed outside a fastening nail, wherein the fastening nail is screwed to a support disposed on a base;
a piezoelectric element, the piezoelectric element being disposed outside the collar;
a mass block, the mass block being disposed outside the piezoelectric element;
wherein the collar is expanded as the fastening nail is screwed to the support, wherein the piezoelectric element is expanded by an expanding force transferred from the collar, and the mass block is expanded by an expanding force transferred from the piezoelectric element.

2. The shear-type piezoelectric sensor as claimed in claim 1, wherein an outer side of the collar has a revolving configuration, and an inner side of the collar has a conical shape with an angle.

3. The shear-type piezoelectric sensor as claimed in claim 1, wherein the angle is calculated based on a moment to be applied to the fastening nail to achieve a predetermined preload.

4. The shear-type piezoelectric sensor as claimed in claim 1, wherein the collar has at least one through cutout.

5. The shear-type piezoelectric sensor as claimed in claim 1, wherein the collar is made of a material selected from one of stainless steel, aluminum alloy, and titanium alloy.

6. The shear-type piezoelectric sensor as claimed in claim 1, wherein the piezoelectric element has a revolving configuration.

7. The shear-type piezoelectric sensor as claimed in claim 1, wherein the piezoelectric element has at least one through cutout.

8. The shear-type piezoelectric sensor as claimed in claim 1, wherein the piezoelectric element is made of a material selected from one of a piezoelectric ceramic and a piezoelectric single crystal.

9. The shear-type piezoelectric sensor as claimed in claim 1, wherein the mass block has a flat bottom surface.

10. The shear-type piezoelectric sensor as claimed in claim 2, wherein the fastening nail is a conical head locking nail having a conical surface, and the conical surface of the fastening nail is matched with a conical surface of the inner side of the collar.

11. The shear-type piezoelectric sensor as claimed in claim 1, further comprising a circuit board, the circuit board being connected to the mass block through the fastening nail.

12. The shear-type piezoelectric sensor as claimed in claim 7, wherein the circuit board includes a voltage-current conversion circuit unit.

13. The shear-type piezoelectric sensor as claimed in claim 7, wherein the circuit board includes a primary integrating circuit unit.

14. The shear-type piezoelectric sensor as claimed in claim 7, wherein the circuit board includes a quadratic integrating circuit unit.

15. A method for manufacturing a shear-type piezoelectric sensor, comprising the steps of:
providing a collar disposed outside a fastening nail, wherein the fastening nail is screwed to a support disposed on a base and wherein the collar is expanded as the fastening nail is screwed to the support;
providing a piezoelectric element disposed outside the collar, wherein the piezoelectric element is expanded by an expanding force transferred from the collar; and
providing a mass block disposed outside the piezoelectric element, wherein the mass block is expanded by an expanding force transferred from the piezoelectric element.
